(19) United States
(12) Patent Application Publication
(10) Pub. No.: US 2007/0177746 A1
(43) Pub. Date: Aug. 2, 2007

(54) Panel type speaker

(76) Inventors: Kazuhiro Kobayashi, Yamanashi (JP); Yoshiro Ohkawa, Kanagawa (JP)

Correspondence Address: BROWDY AND NEIMARK, P.L.L.C.;624 NINTH STREET, NW, SUITE 300, WASHINGTON, DC, 20001-5303, US

(21) Appl. No.: 10/563,356

(22) PCT Filed: Jul. 1, 2004
(86) PCT No.: PCT/JP04/09323

§ 371 Date: Dec. 21, 2006

(30) Foreign Application Priority Data
Jul. 2, 2003 (JP) 2003-189935

(51) Int. Cl. H04R 25/00

(52) U.S. Cl. 381/152; 381/431

(57) ABSTRACT

A panel type speaker according to the present invention includes an exciter having bimorph type beams which are made of a piezoelectric material and in each of which a flexural oscillation is excited, and a beam holding part for holding the beams, and a diaphragm which is attached to the exciter to generate a flexural oscillation based on oscillation transmitted from the exciter and serves as a transparent protective plate for a display. A bottom surface of the beam holding part of the exciter has an area which is greater than or equal to one-fourth of an area of the largest beam of the beams, and is fixed to a surface of the diaphragm so that the exciter is held on the diaphragm. The panel type speaker has high excitation efficiency and a simple structure, making it easy to add an acoustic characteristic regulating mechanism.

### TECHNICAL FIELD

The present invention relates to a panel type speaker of an oscillation mode system, in particular, a panel type speaker suitable to be combined with a thinned display such as a liquid crystal panel, a plasma panel or the like.

### BACKGROUND ART

The Applicant of this application has already filed a number of applications about a panel type speaker of an oscillation mode system (Patent Documents 1, 2 and 3). The oscillation mode type speaker has a structure in which a leading end surface of a bobbin for holding a voice coil of an electromagnetic type exciter (oscillation device) is attached to a back surface of a flat plate (panel) whose peripheral portion is fixed through a soft elastic body, and a magnetic circuit of the exciter is fixed to a case and so on in the same way through a soft elastic body.

By reciprocation of the bobbin in a forward and backward direction, a flexural oscillation is excited in the panel fixed to the leading end surface of the bobbin. This kind of sound production system is referred to as an oscillation mode system or distributed mode (DM) system, because the flexural oscillation is the main cause of the sound production, rather than the reciprocation of the panel in the forward and backward direction. Advantageous effects of the panel type speaker of the oscillation mode system lie in the achievement of a high sound quality and a thinned structure.

Furthermore, the Applicant has also already filed an application about a panel type speaker suitable to be combined with a thinned display such as a liquid crystal panel, a plasma panel or the like (Patent Document 4).

The panel type speaker is structured to allow a translucent flat plate (panel) such as a protective cover, polarized filter or the like which is disposed in front of the thinned display to serve as a diaphragm of the panel type speaker of the oscillation mode system.

In addition, a basic structure and a principle of the panel type speaker according to the present invention are disclosed in Patent Documents 5 and 6.

Patent Document 1: Japanese Patent Laid-Open No. H10-243491 (FIG. 1 to FIG. 3)

Patent Document 2: Japanese Patent Laid-Open No. H11-331966 (FIG. 1 and FIG. 2)

Patent Document 3: Japanese Patent Laid-Open No. H11-331969 (FIG. 1 to FIG. 3)

Patent Document 4: Japanese Patent Laid-Open No. 2001-189978 (FIG. 1 to FIG. 5)

Patent Document 5: Japanese Patent Laid-Open No. 2002-539699

Patent Document 6: Japanese Patent Laid-Open No. 2003-520540

### DISCLOSURE OF THE INVENTION

Problems to be Resolved by the Invention

In the panel type speaker of the oscillation mode system using an electromagnetic type exciter as disclosed in Patent Document 4 as mentioned above, because the diaphragm having a large area and serving as the protective plate of the display is configured to be excited by a leading end surface of a small area of the electromagnetic exciter, a sufficient excitation efficiency is not acquired, and there is room for improvement.

Moreover, in the conventional panel type speakers, there is also a problem that a mechanism for holding the electromagnetic type exciter is required, and the structure may become complicated.

Furthermore, conventional panel type speakers suffer a further problem with sound quality, since it is difficult to add a regulating mechanism for compensating sound quality to the electromagnetic type exciter.

In addition, a basic structure of the panel type speaker is disclosed in Patent Documents 5 and 6.

An object of the present invention is to enhance handling and reliability of the exciter using bimorph type beams.

Means for Resolving the Problems

A panel type speaker according to the present invention includes an exciter having bimorph type beams which are made of a piezoelectric material and in each of which a flexural oscillation is excited, and a beam holding part for holding the beams, and a diaphragm which is attached to the exciter to generate a flexural oscillation based on oscillation transmitted from the exciter and serves as a transparent protective plate for a display.

Also, a bottom surface of the beam holding part of the exciter has an area which is greater than or equal to one-fourth of an area of the largest beam of the beams, and is fixed to a surface of the diaphragm so that the exciter is held on the diaphragm.

Effect of the Invention

Because the panel type speaker according to the present invention has the structure in which the flexural oscillation is generated in the diaphragm serving also as the transparent protective plate for the display by the exciter having bimorph type beams in which the flexural oscillation is excited and the holding part longer than or equal to a quarter of the length of the beams, the area of the connecting portion of the holding part with the diaphragm can be enlarged to accomplish a high excitation efficiency and firm fixation.

There is an additional advantage that the holding mechanism of the exciter is simple in structure compared with that of the electromagnetic type.

Furthermore, in the exciter according to the present invention, it is easy to add a regulating mechanism for compensating sound quality so that a high sound quality can be achieved.

### BRIEF DESCRIPTION OF THE DRAWINGS

FIG. 1 is a perspective view in which a panel type speaker according to the present invention and a liquid crystal display are combined.

FIG. 2 is an enlarged perspective view showing an exciter of the panel type speaker in FIG. 1.

FIG. 3 is an enlarged perspective view showing an exciter of the panel type speaker in FIG. 1, viewed from the opposite side.

FIG. 4 is a front view showing a structure of an exciter of a panel type speaker in another embodiment according to the present invention.

FIG. 5 is a view showing experimental data comparing a sound pressure level to a frequency characteristic of the panel type speaker shown in FIG. 4 with another panel type speaker having no acoustic characteristic regulating mechanism AD.

FIG. 6 is a front view showing a structure of a panel type speaker in yet another embodiment according to the present invention.

FIG. 7 is a front view showing a structure of an exciter of a panel type speaker in yet another embodiment according to the present invention.

FIG. 8 is a view showing experimental data comparing a sound pressure level to a frequency characteristic of the panel type speaker shown in FIG. 7 with another panel type speaker having no spacer SP.

FIG. 9 is a front view showing a structure of an exciter of a panel type speaker in another further embodiment according to the present invention.

### BEST MODE FOR CARRYING OUT THE INVENTION

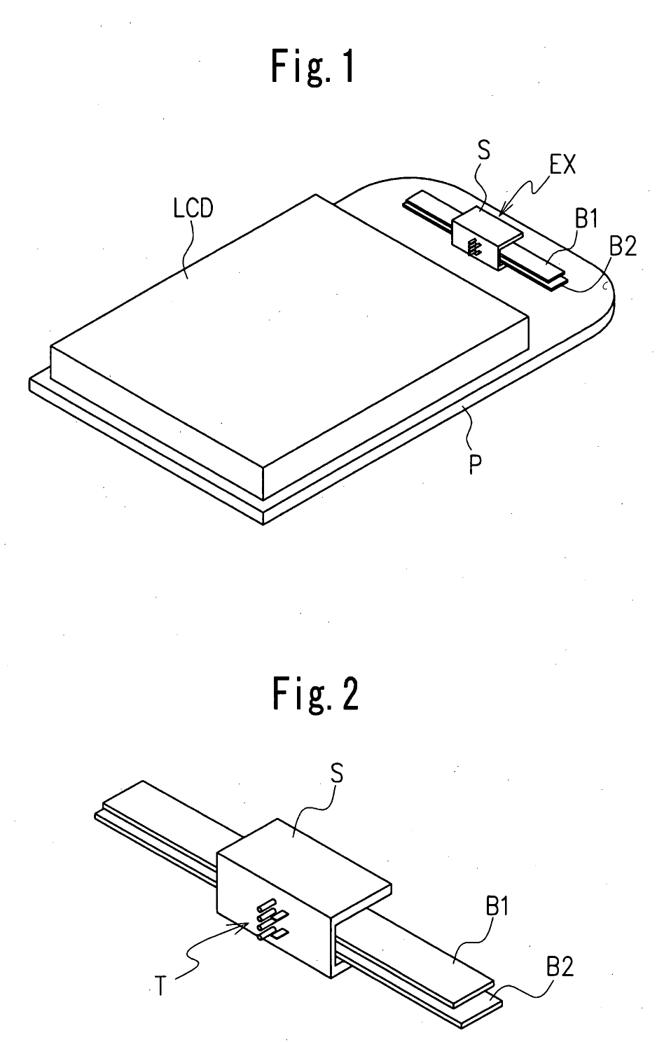

FIG. 1 is a perspective view showing a combination of a panel type speaker according to one embodiment of the present invention and a liquid crystal display. In the perspective view, a back side of the liquid crystal display LCD is shown.

A diaphragm P serving as a transparent protective plate to protect a displaying surface is attached to a front side of the liquid crystal display LCD. The diaphragm P extends to an outside of the displaying surface at one side of the liquid crystal display LCD, and an exciter EX is attached to a back surface of the extended part through an adhesive.

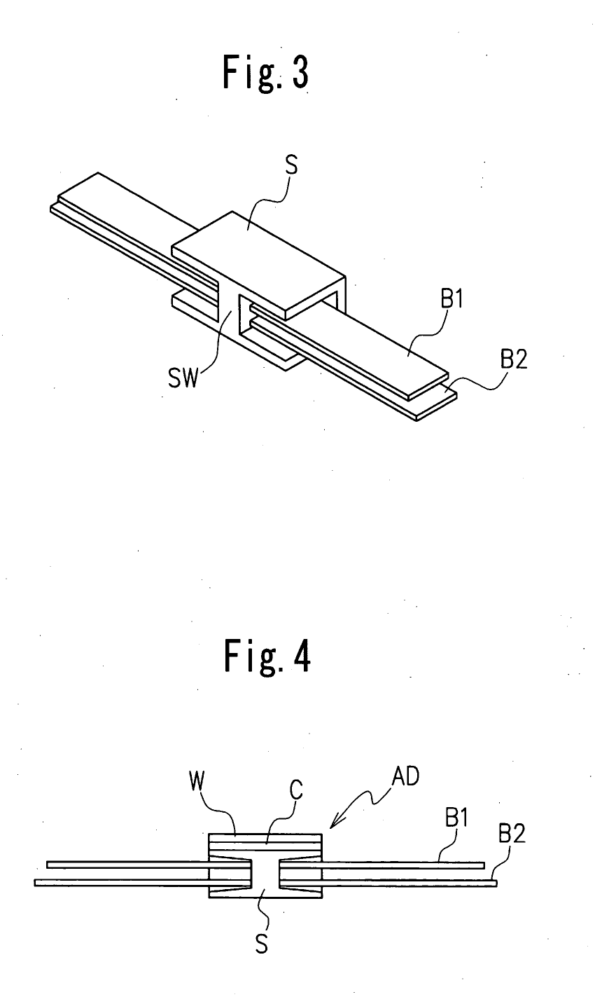

FIGS. 2 and 3 are enlarged views showing a structure of the exciter EX shown in FIG. 1 enlarged; FIG. 2 is an enlarged perspective view as viewed from the same side as FIG. 1 and FIG. 3 is an enlarged perspective view as viewed from the opposite side to FIG. 1.

Referring to FIGS. 1 to 3, the exciter EX comprises two bimorph type beams B1 and B2 each having a different length and a beam holding part S for holding the beams at a central portion thereof.

The beams B1 and B2 each have a bimorph type structure in which a metallic thin film-like electrode is formed on front and back surfaces of an elongate plate-shaped piezoelectric element having a rectangular shape in section through vacuum evaporation or the like. The beam holding part S has a structure in which a beam holding wall SW is formed on a central portion of a U-shaped outer frame and is made of a material such as plastic or the like.

Through holes each having a rectangular shape in section and through which the beams B1 and B2 pass are formed in the beam holding wall SW, the respective central portions of the beams B1 and B2 being fixed and held in the through holes by an adhesive.

An alternating signal voltage is supplied between the electrodes on the front and back surfaces of the beams B1 and B2 through not-shown signal lines and signal terminals T fixed to the beam holding part S corresponding to the signal lines. A flexural oscillation is initiated in each of the beams B1 and B2 depending on the amplitude and frequency of the signal voltage. Because a frequency characteristic of the flexural oscillation depends on the length of each of the beams B1 and B2, the beams B1 and B2 are configured to have different lengths to achieve a wider bandwidth of the frequency characteristic.

The flexural oscillation excited in each of the beams B1 and B2 is transmitted to the beam holding wall SW, and then transmitted from it to a bottom surface of the outer frame of the beam holding part S.

As a result, the bottom surface of the outer frame of the beam holding part S initiates oscillation along a normal line of the diaphragm P to excite a flexural oscillation in the diaphragm P.

By suitably selecting an area of the bottom surface of the outer frame of the beam holding part S based on an output of the exciter EX or a size or thickness of the diaphragm P serving also as a protective plate of the liquid crystal display LCD, an efficient excitation of the flexural oscillation can be obtained, and also by selecting a diaphragm having a larger area, a reliable fixation of the diaphragm to the liquid crystal display LCD can be accomplished.

In order to obtain highly efficient excitation and firm fixation, the area of the bottom surface of the outer frame of the beam holding part S is set to a value of one-fourth or more of the area (length by width) of the larger beam B2, as illustrated.

Moreover, the exciter according to the present invention differs from a conventional electromagnetic type exciter in that neither a holding device for mounting the beam holding part S on the liquid crystal display LCD nor a frame or the like for housing the liquid crystal display is necessary, so that a fixing structure is simplified.

FIG. 4 is a front view showing a structure of an exciter of a panel type speaker according to another embodiment of the present invention.

In this drawing, structural elements to which the same reference numbers as in FIGS. 1 to 3 are attached correspond to those mentioned in connection with the other drawings, so that a duplicated description of them is omitted.

In this embodiment, the exciter has a structure in which an acoustic characteristic regulating mechanism AD is added to a top surface of the beam holding part S for holding the beams B1 and B2. The acoustic characteristic regulating mechanism AD has a structure in which a plate C made of polyurethane foam and a metallic plate W are laminated on the top surface of the beam holding part S by an adhesive.

Potential energy is mainly accumulated and released depending on expansion and contraction of the polyurethane foam plate C in a direction of thickness thereof, and kinetic energy is mainly accumulated and emitted depending on upward and downward oscillation of the metallic plate W. As a result, a resonance occurs in the acoustic characteristic regulating mechanism at a frequency at which the accumulated and emitted potential and kinetic energies are equal.

For a large attenuation of oscillation within the polyurethane foam plate C, a Q value of the resonance is lowered and an excess sound pressure level at the resonance frequency is reduced. Therefore, the sound pressure level to frequency characteristic is flattened by addition of the acoustic characteristic regulating mechanism AD.

FIG. 5 is a view showing experimental data for the effect of the addition of the acoustic characteristic regulating mechanism AD.

A broken line is experimental data showing the sound pressure level to frequency characteristic before adding the acoustic characteristic regulating mechanism AD, and a solid line is experimental data showing the sound pressure level to frequency characteristic after adding the acoustic characteristic regulating mechanism AD.

By adding the acoustic characteristic regulating mechanism AD, a midrange sound pressure level in particular is lowered, and the sound pressure level to frequency characteristic is flattened generally.

According to the above-mentioned embodiment of the present invention, improvement is achieved in characteristics such as the planarization of the sound pressure level to frequency characteristic by addition of the acoustic characteristic regulating mechanism AD having a resonance point in the frequency range of the panel type speaker to the top surface of the beam holding part S of the exciter.

In addition, according to the above-mentioned embodiment, by adopting a laminated structure of a cushion layer and a metallic plate as the acoustic characteristic regulating mechanism, the Q value of resonance to the flexural oscillation of the beams is lowered, and acoustic characteristics such as the planarization of the sound pressure level to frequency characteristic are improved.

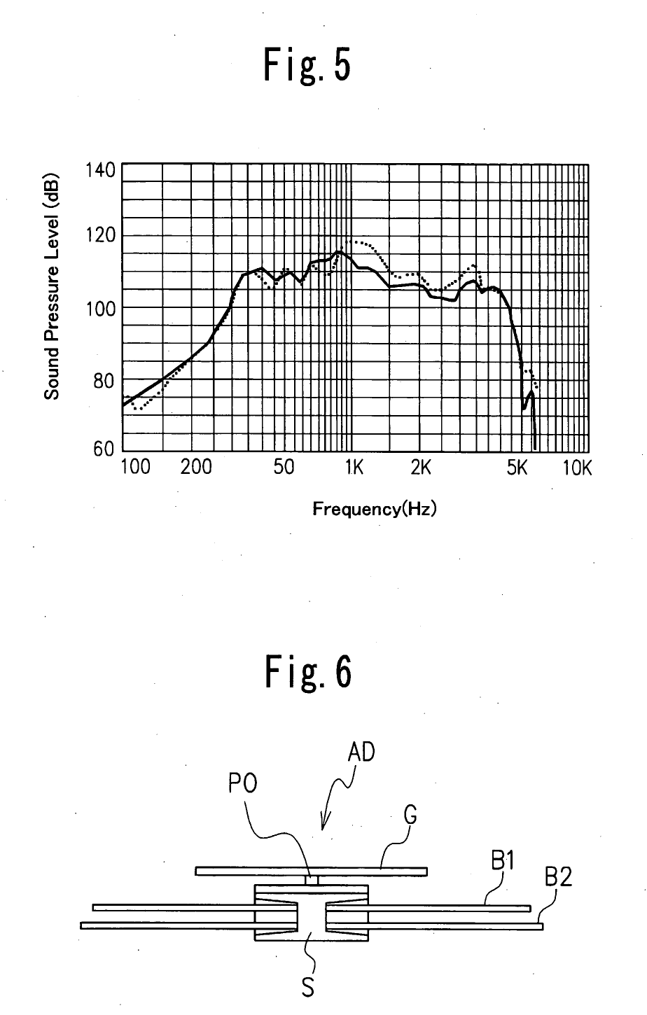

FIG. 6 is a front view showing a structure of an exciter of a panel type speaker in yet another embodiment according to the present invention.

In this drawing, structural elements to which the same reference numbers as in FIGS. 1 to 4 are attached correspond to those mentioned in connection with the other drawings, so that a duplicated description of them is omitted.

In this embodiment, the acoustic characteristic regulating mechanism AD is formed from a plated spring G. That is to say, a circular post PO of small diameter is formed on the top surface of the beam holding part S and the plated spring G made of phosphor bronze is fixed on a top surface of the post PO by an adhesive.

A flexural oscillation is excited in the plated spring G, the oscillation energy is consumed within the plated spring, thereby planarization of the sound pressure level to frequency characteristic, similar to that in FIG. 4, is accomplished.

According to the above-mentioned embodiment of the present invention, by adopting the structure of the plated spring G or the like extending along the longitudinal direction of the beams as the acoustic characteristic regulating mechanism AD, the Q value of resonance of the acoustic characteristic regulating mechanism AD to the flexural oscillation of the beams is lowered, and acoustic characteristics such as the planarization of the sound pressure level to frequency characteristic are improved.

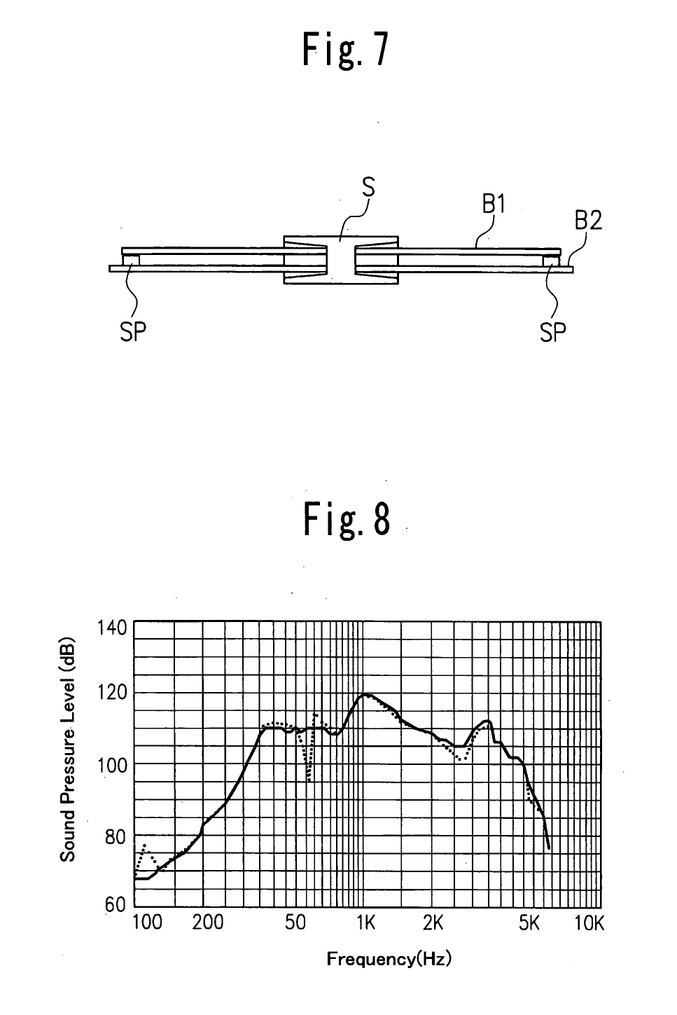

FIG. 7 is a front view showing a structure of an exciter of a panel type speaker in yet another embodiment according to the present invention.

In this drawing, a duplicated description concerning the already mentioned structural elements is omitted. In this embodiment, the exciter has a structure in which a cuboid-like spacer SP made of polyurethane is fixed to a surface of the beam B2 facing an end of the beam B1 by an adhesive.

The spacer SP fulfills an amplitude restriction function by restricting the amplitude of the flexural oscillation of the beams B1 and B2 to a certain value or less. In other words, if the amplitude of the flexural oscillation of beams B1 and B2 increases and the ends of the beams tend to approach each other to within a certain distance or less, the approach is prevented by the spacer.

FIG. 8 is a view showing experimental data for the effect of adding the above-mentioned spacer SP.

A broken line is experimental data showing the sound pressure level to frequency characteristic before adding the spacer SP, and a solid line is experimental data showing the sound pressure level to frequency characteristic after adding the spacer SP. By adding the spacer SP, the variation in width of the sound pressure level to frequency in the mid and lower sound range in particular is lessened, and the sound pressure level is flattened.

According to the above-mentioned embodiment of the present invention, because the beams are structured in such a way that the two beams B1 and B2 have different lengths, and the elastic spacer SP is fixed to one of the beams so that the interval between the one beam and the other beam is held to a certain value or more, planarization of the sound pressure level to frequency characteristic is accomplished.

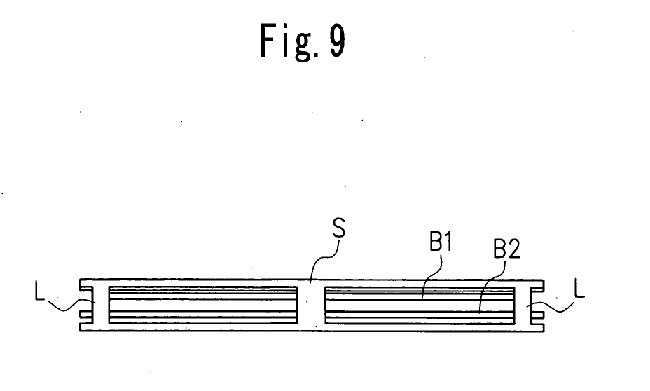

FIG. 9 is a front view showing a structure of an exciter of a panel type speaker in another further embodiment according to the present invention.

In this embodiment, the exciter has a structure in which the beam holding part S is extended in the longitudinal direction of the beams B1 and B2 to completely contain the beams B1 and B2 in the beam holding part S, thereby serving as a case.

Coupling sections L are formed at opposite ends of the beam holding part S to increase rigidity of the beam holding part so that a flexural oscillation is prevented from being excited in a longitudinal direction of the beam holding part S serving as the case.

In this way, the beam holding part S of the exciter is extended in the longitudinal direction of the beams B1 and B2 to contain the beams therein and serves a protective function for the beams by having a box-shaped structure. Moreover, the exciter is configured to be fixed securely with increased strength by a two-sided tape, adhesive or the like to the diaphragm which is disposed at the front of the display and serves as a protection for the display.

According to the above-mentioned embodiment of the present invention, because the beams B1 and B2 having a thin and fragile structure are contained in the beam holding part S of the exciter serving as the case, there is absolutely no possibility that the beams are broken due to the hands of a worker coming into contact with the beams during assembly of the exciter.

Moreover, even if the beams are deflected excessively by a large impact occurring when the exciter drops, because the deflection is blocked by the case containing the beams, breakage of the beams due to excessive deflection is prevented.

In addition, even if excessive deflection of the beams occurs due to an excessive electric signal, the beams are protected by the case.

The above refers to an example in which the beam holding part S of the exciter has a rectangular bottom surface. However, any appropriate shape such as a circular shape, an elliptic shape or the like, can be selected for the bottom surface, if required.

### DESCRIPTION OF NUMERALS

LCD liquid crystal display
P diaphragm serving as a transparent protective plate for the liquid crystal display
EX exciter using bimorph type beams
B1, B2 bimorph type beams
S beam holding part
SW beam holding wall
AD acoustic characteristic regulating mechanism
C plate of polyurethane foam
W metallic plate
G plated spring
SP spacer of polyurethane foam
L coupling sections

1. A panel type speaker comprising:
an exciter including bimorph type beams which are made of a piezoelectric material and in each of which a flexural oscillation is excited, and a beam holding part for holding the beams; and
a diaphragm which is attached to the exciter to generate a flexural oscillation based on oscillation transmitted from the exciter and serves as a transparent protective plate for a display,
characterized in that
a bottom surface of the beam holding part of the exciter has an area which is greater than or equal to one-fourth of an area of the largest beam of the beams, and is fixed to a surface of the diaphragm so that the exciter is held on the diaphragm.

2. The panel type speaker in claim 1,
characterized in that an acoustic characteristic regulating mechanism having a resonance point in a frequency range of the speaker is formed on a top surface of the beam holding part of the exciter.

3. The panel type speaker in claim 2,
characterized in that the acoustic characteristic regulating mechanism includes an elastic layer fixed to the flat top surface of the beam holding part of the exciter and a weight fixed on the elastic layer.

4. The panel type speaker in claim 2,
characterized in that the acoustic characteristic regulating mechanism is structured from a plated spring which is fixed to the top surface of the beam holding part of the exciter and extending along a longitudinal direction of the beams.

5. The panel type speaker in claim 1,
characterized in that the beams of the exciter comprise two beams having different lengths, and
characterized in that an elastic spacer is fixed to one beam to preserve a certain interval or more between the beams.

6. The panel type speaker in claim 1,
characterized in that the beam holding part is extended in a longitudinal direction of the beams of the exciter, contains the beams in the beam holding part, and has a box-shaped structure.

7. The panel type speaker in claim 5,
characterized in that the beam holding part is extended in a longitudinal direction of the beams of the exciter, contains the beams in the beam holding part, and has a box-shaped structure.

8. The panel type speaker in claim 4,
characterized in that the beams of the exciter comprise two beams having different lengths, and
characterized in that an elastic spacer is fixed to one beam to preserve a certain interval or more between the beams.

9. The panel type speaker in claim 8,
characterized in that the beam holding part is extended in a longitudinal direction of the beams of the exciter, contains the beams in the beam holding part, and has a box-shaped structure.

10. The panel type speaker in claim 2,
characterized in that the beams of the exciter comprise two beams having different lengths, and
characterized in that an elastic spacer is fixed to one beam to preserve a certain interval or more between the beams.

11. The panel type speaker in claim 3,
characterized in that the beams of the exciter comprise two beams having different lengths, and
characterized in that an elastic spacer is fixed to one beam to preserve a certain interval or more between the beams.

12. The panel type speaker in claim 10,
characterized in that the beam holding part is extended in a longitudinal direction of the beams of the exciter, contains the beams in the beam holding part, and has a box-shaped structure.

13. The panel type speaker in claim 11,
characterized in that the beam holding part is extended in a longitudinal direction of the beams of the exciter, contains the beams in the beam holding part, and has a box-shaped structure.
